(19) United States
(12) Patent Application Publication
(10) Pub. No.: US 2008/0105345 A1
(43) Pub. Date: May 8, 2008

(54) Tire having an improved sidewall illumination system

(76) Inventors: John Michael Fenkanyn, Akron, OH (US); Robert Leon Benedict, Tallmadge, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/593,913

(22) Filed: Nov. 7, 2006

(51) Int. Cl. B60C 19/00

(52) U.S. Cl. 152/152.1

(57) ABSTRACT

An optical fiber device is affixed to a tire sidewall and powered by a light source affixed to the wheel or tire. Optical fiber cable(s) within the device in a preferred configuration emit a light in one or more colors in response to light signals from the light source. The optical fiber cable(s) may be energized by a controller having multiple color LEDs that are selectively activated by a biasing voltage to transmit colored light from the controller to the optical fiber cables.

### FIELD OF THE INVENTION

The invention relates generally to an illumination system for a tire and, more specifically, to a tire having a light emitting illuminated sidewall.

### BACKGROUND OF THE INVENTION

In various applications, it is desirable to provide illumination to a vehicle wheel for the purpose of safety or to provide a special effect. It is known to utilize reflectors to the wheels of vehicles to make the vehicles more visible. Such reflectors, however, are only visible within a narrow range of incident light. Situated outside of the path of a light source, such devices are not noticeable.

It is further known to use incandescent lights on the exterior of a vehicle to replace reflective devices. Such lighting systems, however, are generally not suitable for incorporation into a wheel of the vehicle due to the size of the incandescent lights, the power requirements needed to power the lighting system, and/or the commuting requirements to provide power to the lighting system.

Another proposed system for illuminating the sidewall of a tire involves mounting a phosphor coated wire to the sidewall and applying a voltage to the wire in order to get the phosphor to illuminate. Different colored plastics jackets can surround the wire in order to change the color of the light emitted. While working well, the step up voltage required to activate the phosphor coated wire requires additional circuitry and associated costs. In addition, the phosphor coating may in certain environments crack or break, causing a loss of the desired electro-luminescent effect.

Other types of lighting systems and arrangements likewise have proven inadequate for illuminating a vehicle wheel because of cost, durability, and flexibility limitations of such systems. Adapting the wheel of a vehicle post-vehicle manufacture to provide illumination capability can be cumbersome and expensive, whereby limiting the commercial appeal of such systems.

Accordingly, there is a need for a means for providing a low-cost, visual means for differentiating the wheel area of vehicle for a consumer. Such a system should be flexible in order to afford customized visual differentiation in a variety of applications. Moreover, a suitable system will be capable of convenient retrofit application to existing vehicles at an acceptable level of cost. An acceptable system should also be durable and capable of withstanding operation on the sidewall of a tire with minimal malfunction, degradation, or breakage.

### SUMMARY OF THE INVENTION

The present invention in one aspect is directed to an illuminated sidewall of a tire. One or more fiber optic cable is affixed to a tire sidewall and powered by a power source affixed to the wheel or tire. One or more white LEDs are used to illuminate the cable(s). Pursuant to an additional aspect of the invention, different colors may be produced by changing the voltage bias on internal color diode(s) coupled to the fiber optic cable(s).

According to another aspect of the invention, the fiber optic cable(s) have an etched outer surface or a doped/etched inner surface for diffusing light outward. According to a further aspect, the fiber optic cable(s) may be in the form of a panel of a preferred design, whereby illumination of the panel will create a pre-selected user preferred design or image in one or more colors. Pursuant to another aspect, fiber optic cables are arranged in preselected shapes and sizes in a preferred form

### BRIEF DESCRIPTION OF THE DRAWINGS

The invention will be described by way of example and with reference to the accompanying drawings in which:

FIG. 1 is a perspective view of a representative tire with a fiber optic device attached thereto;

FIG. 2 is an exploded perspective view of the tire and fiber optic device;

FIG. 3 is a transverse section view of the tire and device taken along the line 3-3 of FIG. 1;

FIG. 4 is an enlarged view of the device and tire sidewall;

FIG. 5 is an enlarged sectional view of the light emitting portion of the device and tire;

FIG. 6 is an enlarged sectional view of a light emitting device portion alternatively mounted to a tire sidewall;

FIG. 7 is an enlarged sectional view of a plurality of light emitting device portions arranged on a tire sidewall.

FIG. 8 is a circuit schematic of optical device drivers and the system.

### DETAILED DESCRIPTION OF THE INVENTION

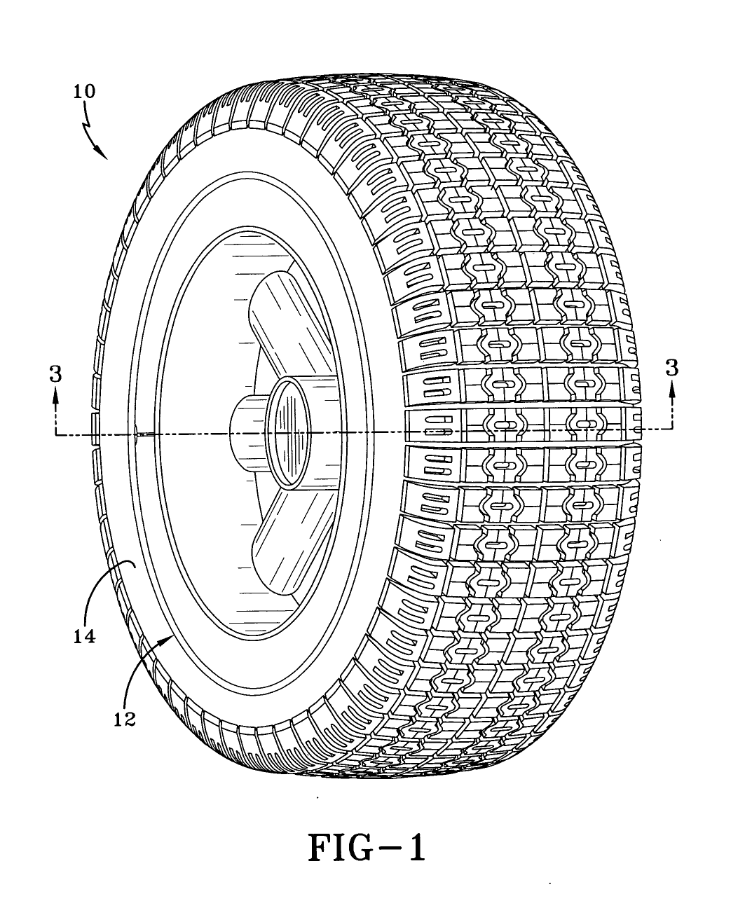

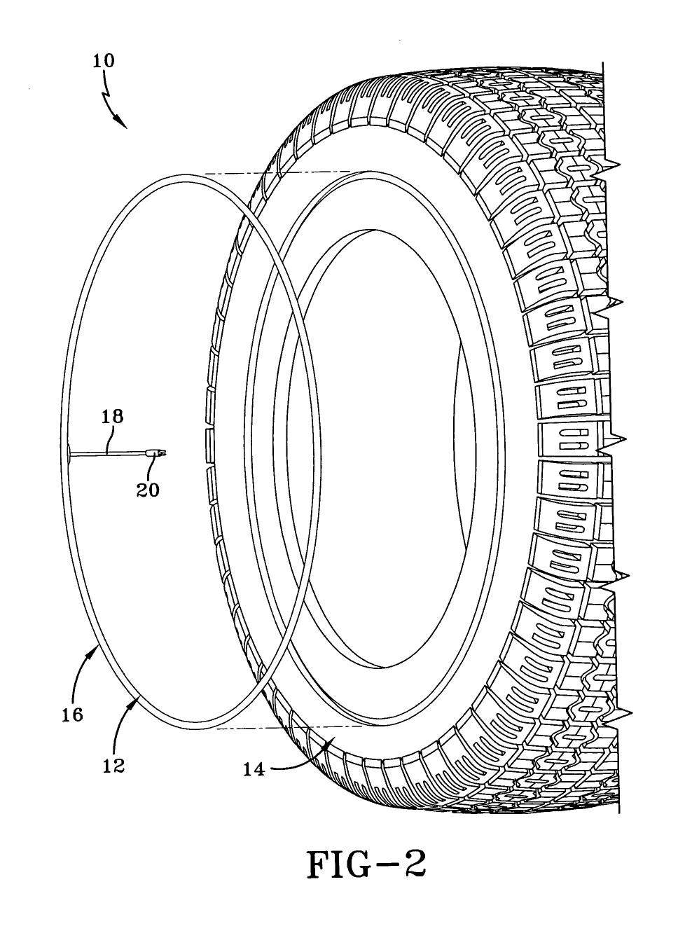

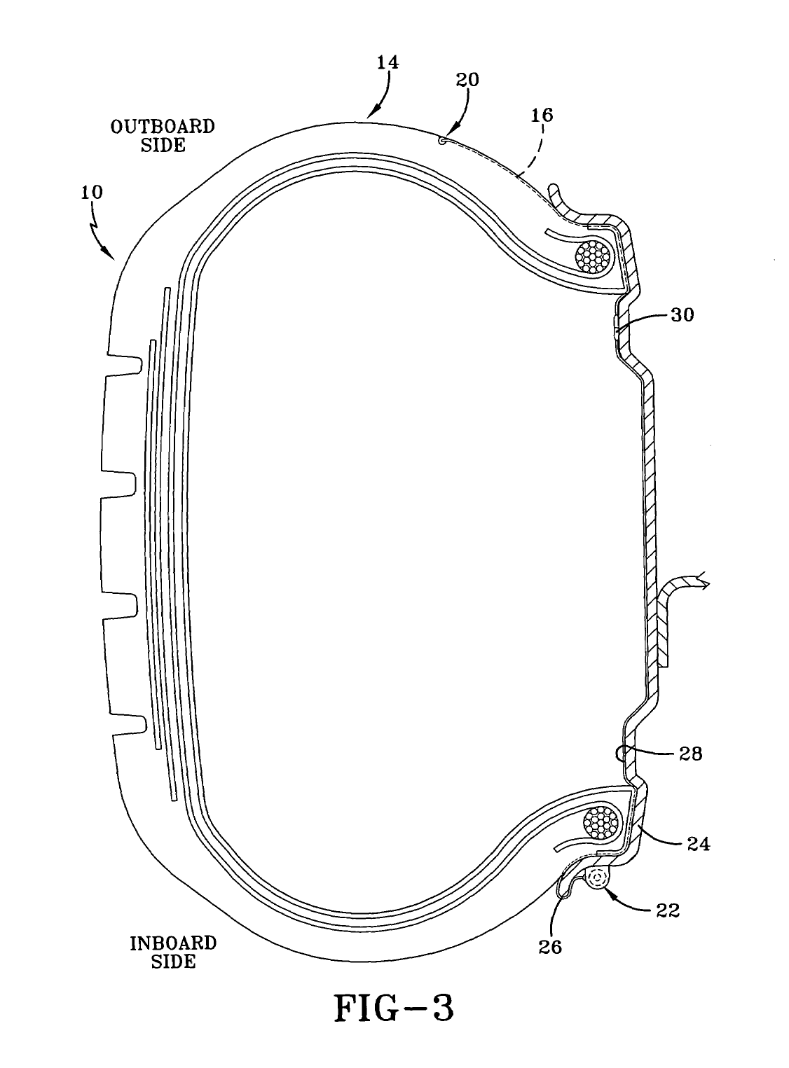

Referring to FIGS. 1, 2, and 3, a tire 10 is shown having a fiber optics device 12 attached to a tire sidewall 14. The device 12 includes a fiber optic cable 16, optical conductors 18 coupled to the cable 16, and a terminal optical connector 20. Cable 16 in device 12 is of a type that conducts light along a pre-selected path. The cable 16 is either unclad or clad with a light transmitting sheath in a manner conventional to commercial optics practice. The cable 16 may further be etched on an outward or inward surface and/or doped so as to diffuse light transmitted through the cable outward, whereby allowing for observable illumination of the cable to viewers. The fiber optic cable, while shown in the embodiment of FIGS. 1-3 in the form of an annular loop of a single fiber 16, may constitute a bundle of fibers configured in a variety of shapes and sizes and may be configured according to the invention as a precut or shaped panel that emits light of various colors when powered.

Accordingly, device 12 may be affixed to the tire sidewall 14 in a preferred configuration such as an annular loop (shown), and/or a panel (shown schematically in FIG. 7). The fiber optic device 12 may be utilized to light the sidewall with various colors as will be explained below. The configuration employed on the sidewall may include personalized lettering, designs, or logos and be used to customize a user's tires on a vehicle or to convey commercial information to other viewers.

The device 12 is powered by a light source 22. Light source 22 may be mounted to the tire but preferably will be mounted to the rim 24 of a wheel by means of a clamping device 26. The light source 22 may utilize batteries that can be accessed and replaced as needed over time. As shown, the light source 22 includes one or more optical conductors 28 that terminate in an optical connector 30 that is configured to mate with the connector 20 of fiber optic device 12. The light source 22 may include control drivers for intermittently powering the optical fiber cable(s) 16, whereby causing the optical fiber cable(s) to flash in regular or irregular intervals, or in conjunction with other vehicle systems.

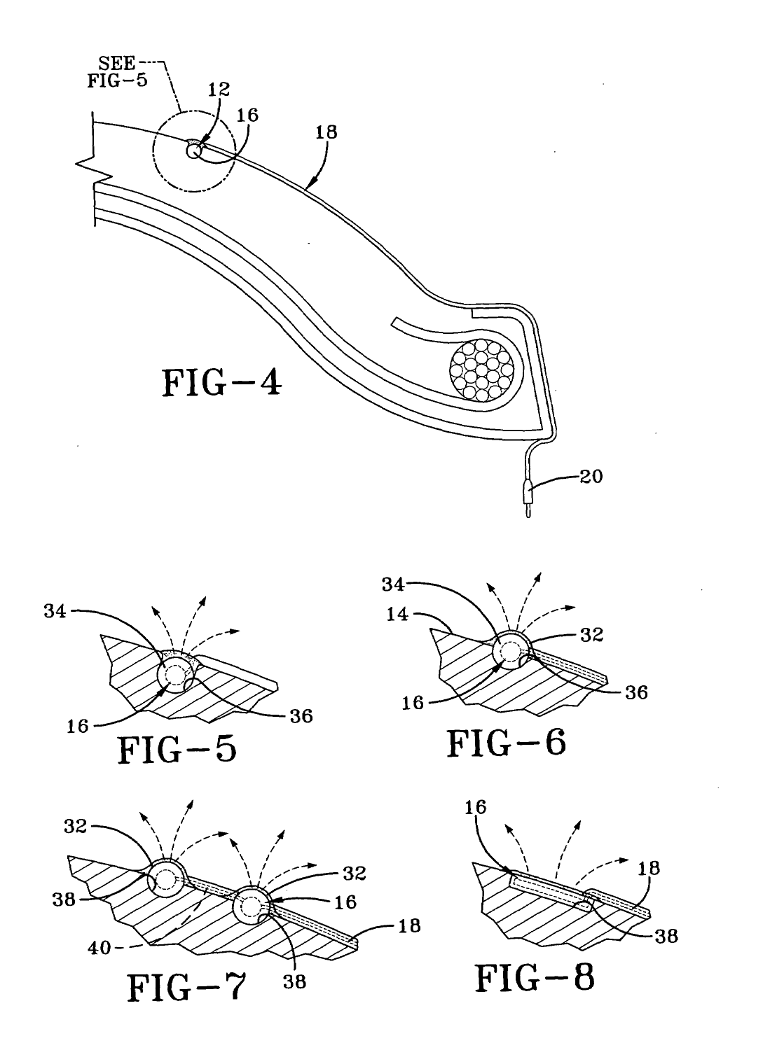

FIGS. 4 and 5 show one form of attachment of the device optical fiber conductor 16 to a tire sidewall 14. The conductor 16 is attached by means of a suitable commercially available adhesive 32 such as an epoxy. As shown, the conductor 16 may further be at least partially covered by a clear commercially available coating or sealant 34 that can function to aid in wire durability over time. The device 12 may be added in retrofit manner to existing tires or as part of an original tire manufacturing line. A recess or groove 36 may be formed into a tire sidewall as shown. The optical fiber cable(s) 16 is generally of small size. Due to the small size of the optical fiber cable, the recess or groove 36 does not have to be very large. Using a conventional adhesive, the optical fiber cable 16 can be attached to the tire in a post-cure procedure. For example, without any intention to delimit the invention, a clear urethane may be used to seal and weatherproof the optical fiber cable 16 in the sidewall 14.

FIG. 6 shows a shallower groove or recess 38, resulting in the optical fiber cable 16 protruding from the sidewall 14 a greater extent. The configuration and size of the recess 38, and the optical fiber cable 16 seated therein relative to the sidewall 14 may be designed as required for the desired visual effect.

FIG. 7 shows a multi-fiber cable representation in which multiple optical fiber cables 16, 40 are deployed within a tire sidewall 14, such as in a panel or logo configuration. Each optical fiber cable 16, 40 may be separately connected to a remote light source and controllers in order for the illumination of each fiber optic cable to be separately controlled. Different colors may be achieved through the use of colored light emitting LEDs as explained below to create a desired visual effect.

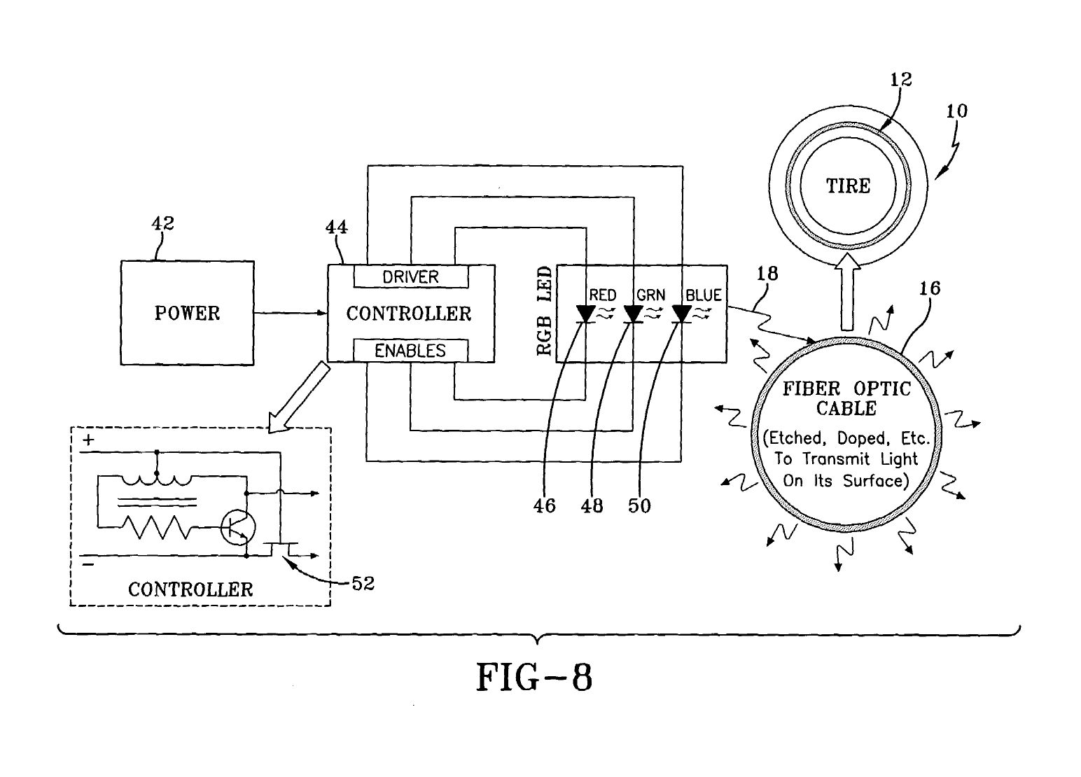

With reference to FIG. 8, the optical controller for the optical fiber cable(s) 16 will be explained. A power supply 42, preferably battery based, is used to power a controller 44 which in turn controls the operation of a bank of color internal diodes 46, 48, 50. Output optical is directed by means of optical conductor 18 to the optical device cable(s) 16 mounted to the tire 10. The power supply powers one or more white LEDs in the system. A biasing voltage output from circuit 52 is selectively applied to the diodes 46, 48, 50, switching the diodes on or off as desired. White light LEDs are used to illuminate the cable (16). Using a white LED allows different colors to be produced by changing the voltage bias on the red, green, and blue internal diodes 46, 48, 50.

From the foregoing, it will be appreciated that the subject invention uses an optical fiber device including an optical fiber cable(s) and/or panels made therefrom to illuminate a tire sidewall in a desired pattern. Such optical fiber cables and/or panels create lighted designs and images on the sidewalls in preselected shapes, sizes, and colors. The subject invention illuminates the use of copper wire such as in phosphor wire based systems, wire that may eventually fatigue and break. The optical fiber cables used in the invention are thus durable and dependable. In addition, the subject invention uses white LEDs that allow color differentiation through selective switching a biasing voltage applied to color diodes. The jacketing necessary to provide color differentiation in a phosphor wire based system is thereby eliminated. Still further, the invention uses a relatively inexpensive and less complex controller circuitry to power the LEDs. The invention therefore provides a low cost means for achieving visual customization and differentiation of tires and vehicles for the consumer.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising:
a tire sidewall;
an optical fiber device affixed to the tire sidewall;
a light source coupled to energize the optical fiber device, the light source including at least one LED for illuminating the optical fiber device.

2. A tire according to claim 1, wherein the optical fiber device comprises at least one optical fiber cable.

3. A tire according to claim 2, wherein the tire sidewall includes a recess receiving the at least one optical fiber cable at least partially therein.

4. A tire according to claim 3, wherein the recess is incorporated into the tire with the tire in a pre-cure stage of manufacture.

5. A tire according to claim 3, wherein the at least one optical fiber cable is secured to the tire sidewall by adhesive.

6. A tire according to claim 3, wherein the at least one optical fiber cable is at least partially covered with a protective coating.

7. A tire according to claim 1, wherein further comprising a controller for selectively transmitting color differentiated light to the optical fiber device in a programmed pattern.

8. A tire according to claim 1, wherein the LED is a white light LED.

9. A tire according to claim 8, wherein further comprising a controller comprising at least one color diode optically coupled between the LED and the optical fiber device, a voltage bias means for selectively applying an actuating biasing voltage to the one color diode, whereby switching the one color diode on and transmitting colored light from the color diode to the optical fiber device.

10. A tire according to claim 1, wherein the optical fiber device forms a panel of a pre-selected design.

11. A tire according to claim 10, wherein the optical fiber device comprises a plurality of optic fiber cables and a controller, the controller comprising at least one color diode optically coupled between the LED and the optical fiber cables, a voltage biasing means for selectively applying an actuating biasing voltage to the one color diode, whereby turning the one color diode on and transmitting colored light from the color diode to at least one of the optical fiber cables.

12. A tire according to claim 1, wherein the optical fiber device includes at least one optical conductor having a connector affixed to a remote end coupling with the light source.

13. A tire according to claim 13, wherein the light source is attached to a wheel supporting the tire.
